(19) United States
(12) Patent Application Publication
(10) Pub. No.: US 2013/0095575 A1
(43) Pub. Date: Apr. 18, 2013

(54) Methods for Fractionation, Analysis and Collection of Microvesicles From Patient Samples

(71) Applicant: The Board of Trustees of the Leland Stanford Junio, Palo Alto, CA (US)

(72) Inventors: Jennifer Jones, Palo Alto, CA (US); Susan Jane Knox, Stanford, CA (US)

(73) Assignee: The Board of Trustees of the Leland Stanford Junior University, Palo Alto, CA (US)

(21) Appl. No.: 13/633,766

(22) Filed: Oct. 2, 2012

Related U.S. Application Data
(60) Provisional application No. 61/542,742, filed on Oct. 3, 2011.

(51) Int. Cl. G01N 21/64

(52) U.S. Cl. CPC G01N 21/6486
USPC 436/501

(57) ABSTRACT

A methods are provided for the flow cytometry profiling of microvesicles, including exosomes.

### BACKGROUND

Exosomes are 40-150 nm vesicles secreted by a wide range of mammalian cell types. Exosomes are one of many different sub-populations of microvesicles that can be isolated from biofluids such as blood, urine and cerebrospinal fluid (CSF) and from which high quality RNA and DNA can be extracted and purified for analysis. Exosomes are shed by cells under both normal and pathological conditions. Most exosomes studied to date have an evolutionary-conserved set of protein molecules and a set of tissue/cell type-specific proteins that distinguishes exosomes secreted by different cell types. The RNA molecules in exosomes include mRNA and miRNA, which can be shuttled from one cell to another, affecting the recipient cell's protein production.

Exosomes are characterized in their biogenesis by formation of intraluminal vesicles (ILVs) through the inward budding of endosomes to form multivesicular bodies (MVBs). These MVBs then fuse with the outer cell membrane to release their cargo of ILVs (now exosomes) to the extracellular environment. The endosome is first formed by inward budding of the cell membrane by endocytosis and leads to inversion of the lipid membrane, trapping some of the extracellular environment on the intraluminal side. Similarly, the second inward budding of the endosome membrane traps a volume of the cell's cytoplasm and results in a positive orientation of the ILVs lipid membrane. When the ILVs (now exosomes) are released to the extracellular environment, they have the same orientation as the cell membrane and have been shown to display many of the surface markers from their cell of origin. However, the sorting process of membrane proteins during ILV formation is an active process and thus, exosomal surface proteins are not a simple one-to-one representation of the surface markers from the cell of origin.

Tumors are characterized by secretion of various forms of membrane vesicles constitutively. These comprise exosomes, MVs and apoptotic bodies. Released membrane vesicles contain tumor-specific antigens on their surface, e.g., Her2/Neu mesothelin, MelanA/Mart-1, CEA, HER-2, and EGFRvIII. Furthermore, membrane vesicles from cancer cells contain RNA. Several reports indicate that miRNA-based identification of cancer leads to a reliable characterization of the origin and development of tumors. As certain miRNAs are characteristic for tumors, their presence within tumor-derived exosomes and MVs may also serve as novel biomarkers of cancer.

Examples for key functions of exosomes include antigen presentation and immunostimulatory and inhibitory activities. Current methods of isolation and analytical methods include differential centrifugation and subsequent sucrose gradient ultracentrifugation, transmission electron microscopy (TEM), western blot and mass spectroscopy. One protocol for exosome isolation includes ultracentrifugation and a subsequent sucrose density gradient ultracentrifugation or, alternatively, sucrose cushion centrifugation. However, during differential centrifugation prior to pelleting of a given membrane vesicle population, some of the respective vesicles may be selectively depleted. A problem of alternative protocols is that forced filtration of membrane vesicles holds the risk of fragmentation into smaller vesicles.

Conventionally, flow cytometry detects vesicles above approximately ˜200 nm, and therefore exosomes and smaller MVs cannot be analyzed directly by this method. Vesicles smaller than the detection limit of the used flow cytometer cannot be discriminated from the instrument noise, leading to an inadequate numbering of MVs. Flow cytometry efforts for detection of small vesicles are described by Robert et al. (2009) J Thromb Haemost. 7(1):190-7; and Lacroix et al. (2010) J Thromb Haemost.

### SUMMARY

Methods are provided for the flow cytometry profiling of microvesicles, including exosomes; and the use of the profiling in a variety of clinical and research applications. Antigen presenting cells and tumor cells, among others, produce large quantities of submicron particles, i.e. exosomes and microparticles, which modulate tumor immune responses and the tumor microenvironment. Submicron biological particles have been difficult to study and sort for functional studies. The present invention provides nanoFACS, methods that allow one to analyze, sort, and study submicron particles in functional form, without using electron microscopy or aggregation to beads, which change the biological properties of the particles. A cytometer was configured for maximal resolution of small particles. Non-specific background noise was reduced by adding both a filter and a small particle detector, as well as tuning the nozzle height to eliminate drop drive noise.

The microvesicles are obtained from any convenient biological sample. Serum samples from an individual are a preferred sample, which may be treated in various ways, including binding to affinity reagents for identification and sorting. For example, samples may be stained with antibodies that selectively bind to markers of immune cells, tumor markers, markers of radiation exposure, and the like. The microvesicles may also be sorted and analyzed for the presence of nucleic acids of interest, such as RNA, including microRNA/

Aspects of the invention include analysis of the quantity and/or quality (for example the presence of protein or nucleic acid markers of interest) of microvesicles for monitoring of tumor responses to cytotoxic therapies (e.g. chemotherapy and radiation therapy). Aspects of the invention include analysis of the quantity and/or quality (for example the presence of protein or nucleic acid markers of interest) of microvesicles for monitoring immune responses to tumor vaccines. Aspects of the invention include analysis of the quantity and/or quality (for example the presence of protein or nucleic acid markers of interest) of microvesicles for monitoring immune cells following transplantation, including the development of graft v host disease. Aspects of the invention include analysis of the quantity and/or quality (for example the presence of protein or nucleic acid markers of interest) of microvesicles for biodosimetry, for assessing the level of radiation exposure (e.g. from a nuclear accident, dirty bomb, etc). Such analysis may include detecting the number of microvesicles relative to total serum protein levels, and may include determining the presence of annexin V on the microvesicles. Aspects of the invention include analysis of the quantity and/or quality (for example the presence of protein or nucleic acid markers of interest) of microvesicles which is incorporated into a point of care device for purposes of identifying individuals with radiation exposure or specific infections. In an embodiment, the method further comprises assessing a clinical factor in the mammalian subject; which may be a human subject, and combining the assessment with the analysis of microvesicles.

In some embodiments, a patient sample, e.g. a serum sample, is analyzed for the presence of microvesicles, which may be exosomes, comprising markers of interest. Analysis may include mass spectroscopy, but preferably utilizes flow cytometry with the methods of the invention. Markers of interest include radiation specific markers, tumor specific markers, immune cell, including antigen presenting cell such as dendritic cell markers, and the like.

Assessment in a patient allows improved care, where patients classified according to responsiveness can be treated with an appropriate agent. Patients can be classified upon initial presentation of symptoms, and can be further monitored for status over the course of the disease to maintain appropriate therapy, or can be classified at any appropriate stage of disease progression. Treatment of particular interest includes radiation, e.g. including therapeutic radiation to reduce tumor size.

In other embodiments of the invention a device or kit is provided for the analysis of patient samples. Alternatively the reagents can be provided as a kit comprising reagents in a suspension or suspendable form, e.g. reagents bound to beads suitable for flow cytometry, and the like. The instructions may comprise instructions for conducting an antibody-based flow cytometry assay.

In an embodiment, the method further comprises selecting a therapeutic regimen based on the analysis. In an embodiment, the method further comprises determining a treatment course for the subject based on the analysis.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1. A. Flow Cytometry with Influx Small Particle Detection. B. Multicolor Subset Identification/Sorting. C. Electron microscopy confirms that FSC+ (red box B) is composed of microparticles rather than D. exosomes, which were sorted as the FSC—population (blue box B). E. DLS-NTA confirms that nano FACS sorts specific 40-1000 nm submicron populations (50-100 nm population shown; from bulk submicron populations (F)).

FIG. 2. FSC and SSC gains were adjusted to place the signals from 500 nm beads at the tops of Log FSc and Log SSc. Particle sizes are shown in nm.

FIG. 3. Comparison of background noise reduction with 100 nm (right) and 20 nm (left) sheath fluid line filtering. Addition of a 0.1 nm filter for the sheath fluid near the nozzle minimizes background noise. A small improvement in noise reduction was observed with 0.02 nm inline filtering, but 0.02 nm filtering substantially required increased fluidic pressures and reduced flow rate stability in the system, so, in our experience, a 0.1 nm filter is more generally useful. When studying samples at flow rates of >2000 events per second, 20-40 background noise rates have minor contributions to particle analysis and sorting.

FIG. 4. Optimal FSC resolution in the nanoFACS range depends on ability to filter the sheath fluid, addition of the optical configuration in the BD Influx small particle option, tuning the nozzle height to eliminate noise in the system from the drop drive, and alignment optimization with nanoscale particles. Shown below are plots with SSC triggering at the levels of each systems' optical noise to a SSC background rate of <40 events/second. Conventional FACS configurations (as with the Aria) are able to resolve nonfluorescent 400 nm beads in the SSC dimension, but not the FSC dimension, where the nanoFACS configuration on the Influx is able to resolve unlabeled 400 nm and 100 nm beads, as well as 40-150 nm dendritic cell exosomes above the system SSC noise level (shown as a dashed line through the lower plots).

FIG. 5. Antibody aggregates and labeled exosomes are also able to be resolved with nanoFACS, and this may be useful for many sorting and fractionation needs.

### DETAILED DESCRIPTION

These and other features of the present teachings will become more apparent from the description herein. While the present teachings are described in conjunction with various embodiments, it is not intended that the present teachings be limited to such embodiments. On the contrary, the present teachings encompass various alternatives, modifications, and equivalents, as will be appreciated by those of skill in the art.

Most of the words used in this specification have the meaning that would be attributed to those words by one skilled in the art. Words specifically defined in the specification have the meaning provided in the context of the present teachings as a whole, and as are typically understood by those skilled in the art. In the event that a conflict arises between an art-understood definition of a word or phrase and a definition of the word or phrase as specifically taught in this specification, the specification shall control.

It must be noted that, as used in the specification and the appended claims, the singular forms “a,” “an,” and “the” include plural referents unless the context clearly dictates otherwise.

Compositions and methods are provided for classification and analysis of patients having an inflammatory diseases; exposed to radiation; cancer patients, etc. Marker signature pattern as used herein refers to the spectrum of biomarker on microvesicles. Once the marker levels and pattern for a particular sample are identified, the data can be used in selecting the most appropriate therapy for an individual. By analysis of marker levels on an individual basis, the specific subclass of disease is determined, and the patient can be classified based on the likelihood to respond to treatments of interest. Thus, the marker signature can provide prognostic information to guide clinical decision making, both in terms of institution of and escalation of therapy as well as in the selection of the therapeutic agent to which the patient is most likely to exhibit a robust response.

The information obtained from the marker profile is used to (a) determine type and level of therapeutic intervention warranted (i.e. more versus less aggressive therapy, monotherapy versus combination therapy, type of combination therapy)), and (b) to optimize the selection of therapeutic agents. With this approach, therapeutic regimens can be individualized and tailored according to the specificity data obtained at different times over the course of treatment, thereby providing a regimen that is individually appropriate. In addition, patient samples can be obtained at any point during the treatment process for analysis.

Mammalian species that provide samples for analysis include canines; felines; equines; bovines; ovines; etc. and primates, particularly humans. Animal models, particularly small mammals, e.g. murine, lagomorpha, etc. can be used for experimental investigations. Animal models of interest include those for models of autoimmunity, graft rejection, and the like.

Inflammatory Disease. Inflammation is a process whereby the immune system responds to infection or tissue damage. Inflammatory disease results from an activation of the immune system that causes illness, in the absence of infection or tissue damage, or at a response level that causes illness. Inflammatory disease includes autoimmune disease, which are any disease caused by immunity that becomes misdirected at healthy cells and/or tissues of the body. Autoimmune diseases are characterized by T and B lymphocytes that aberrantly target self-proteins, -polypeptides, -peptides, and/or other self-molecules causing injury and or malfunction of an organ, tissue, or cell-type within the body (for example, pancreas, brain, thyroid or gastrointestinal tract) to cause the clinical manifestations of the disease. Autoimmune diseases include diseases that affect specific tissues as well as diseases that can affect multiple tissues, which can depend, in part on whether the responses are directed to an antigen confined to a particular tissue or to an antigen that is widely distributed in the body.

The immune system employs a highly complex mechanism designed to generate responses to protect mammals against a variety of foreign pathogens while at the same time preventing responses against self-antigens. In addition to deciding whether to respond (antigen specificity), the immune system must also choose appropriate effector functions to deal with each pathogen (effector specificity). A cell critical in mediating and regulating these effector functions are CD4⁺ T cells, which can be subtyped as TH1, TH2, TH17, etc.

Inflammatory diseases of interest include, without limitation graft versus host disease, Secondary Progressive Multiple Sclerosis (SPMS); Primary Progressive Multiple Sclerosis (PPMS); Neuromyelitis Optica (NMO); Psoriasis; Systemic Lupus Erythematosis (SLE); Ulcerative Colitis; Crohn's Disease; Ankylosing Spondylitis; Rheumatoid Arthritis (RA); Diabetes Mellitus type 1 (IDDM); Asthma; Chronic Obstructive Pulmonary Disorder (COPD); Chronic Hepatitis; Amyotrophic Lateral Sclerosis (ALS); Alzheimer's Disease (AD); Parkinson's Disease; Frontotemporal Lobar Degeneration (FTLD), atherosclerosis/cardiovascular disease, and obesity/metabolic syndrome. Applying the methods of the invention with respect to identifying mechanistic biomarkers to these other diseases leads to identification of biomarkers suitable for a diagnostic to predict response to therapy.

The terms “subject,” “individual,” and “patient” are used interchangeably herein to refer to a mammal being assessed for treatment and/or being treated. In an embodiment, the mammal is a human. The terms “subject,” “individual,” and “patient” encompass, without limitation, individuals having cancer. Subjects may be human, but also include other mammals, particularly those mammals useful as laboratory models for human disease, e.g. mouse, rat, etc.

The terms “cancer,” “neoplasm,” and “tumor” are used interchangeably herein to refer to cells which exhibit autonomous, unregulated growth, such that they exhibit an aberrant growth phenotype characterized by a significant loss of control over cell proliferation. Cells of interest for detection, analysis, or treatment in the present application include precancerous (e.g., benign), malignant, pre-metastatic, metastatic, and non-metastatic cells. Cancers of virtually every tissue are known. The phrase “cancer burden” refers to the quantum of cancer cells or cancer volume in a subject. Reducing cancer burden accordingly refers to reducing the number of cancer cells or the cancer volume in a subject. The term “cancer cell” as used herein refers to any cell that is a cancer cell or is derived from a cancer cell e.g. clone of a cancer cell. Many types of cancers are known to those of skill in the art, including solid tumors such as carcinomas, sarcomas, glioblastomas, melanomas, lymphomas, myelomas, etc., and circulating cancers such as leukemias. Examples of cancer include but are not limited to, ovarian cancer, breast cancer, colon cancer, lung cancer, prostate cancer, hepatocellular cancer, gastric cancer, pancreatic cancer, cervical cancer, ovarian cancer, liver cancer, bladder cancer, cancer of the urinary tract, thyroid cancer, renal cancer, carcinoma, melanoma, head and neck cancer, and brain cancer.

The “pathology” of cancer includes all phenomena that compromise the well-being of the patient. This includes, without limitation, abnormal or uncontrollable cell growth, metastasis, interference with the normal functioning of neighboring cells, release of cytokines or other secretory products at abnormal levels, suppression or aggravation of inflammatory or immunological response, neoplasia, premalignancy, malignancy, invasion of surrounding or distant tissues or organs, such as lymph nodes, etc.

As used herein, the terms “cancer recurrence” and “tumor recurrence,” and grammatical variants thereof, refer to further growth of neoplastic or cancerous cells after diagnosis of cancer. Particularly, recurrence may occur when further cancerous cell growth occurs in the cancerous tissue. “Tumor spread,” similarly, occurs when the cells of a tumor disseminate into local or distant tissues and organs; therefore tumor spread encompasses tumor metastasis. “Tumor invasion” occurs when the tumor growth spread out locally to compromise the function of involved tissues by compression, destruction, or prevention of normal organ function.

As used herein, the term “metastasis” refers to the growth of a cancerous tumor in an organ or body part, which is not directly connected to the organ of the original cancerous tumor. Metastasis will be understood to include micrometastasis, which is the presence of an undetectable amount of cancerous cells in an organ or body part which is not directly connected to the organ of the original cancerous tumor. Metastasis can also be defined as several steps of a process, such as the departure of cancer cells from an original tumor site, and migration and/or invasion of cancer cells to other parts of the body.

The term “sample” with respect to a patient encompasses blood and other liquid samples of biological origin, solid tissue samples such as a biopsy specimen or tissue cultures or cells derived therefrom and the progeny thereof. The definition also includes samples that have been manipulated in any way after their procurement, such as by treatment with reagents; washed; or enrichment for certain cell populations, such as cancer cells. The definition also includes sample that have been enriched for particular types of molecules, e.g., nucleic acids, polypeptides, etc. The term “biological sample” encompasses a clinical sample, and also includes tissue obtained by surgical resection, tissue obtained by biopsy, cells in culture, cell supernatants, cell lysates, tissue samples, organs, bone marrow, blood, plasma, serum, and the like. A “biological sample” includes a sample obtained from a patient's cancer cell, e.g., a sample comprising polynucleotides and/or polypeptides that is obtained from a patient's cancer cell (e.g., a cell lysate or other cell extract comprising polynucleotides and/or polypeptides); and a sample comprising cancer cells from a patient. A biological sample comprising a cancer cell from a patient can also include non-cancerous cells.

The term “diagnosis” is used herein to refer to the identification of a molecular or pathological state, disease or condition, such as the identification of a molecular subtype of breast cancer, prostate cancer, or other type of cancer.

The term “prognosis” is used herein to refer to the prediction of the likelihood of cancer-attributable death or progression, including recurrence, metastatic spread, and drug resistance, of a neoplastic disease, such as ovarian cancer. The term “prediction” is used herein to refer to the act of foretelling or estimating, based on observation, experience, or scientific reasoning. In one example, a physician may predict the likelihood that a patient will survive, following surgical removal of a primary tumor and/or chemotherapy for a certain period of time without cancer recurrence.

As used herein, the terms “treatment,” “treating,” and the like, refer to administering an agent, or carrying out a procedure, for the purposes of obtaining an effect. The effect may be prophylactic in terms of completely or partially preventing a disease or symptom thereof and/or may be therapeutic in terms of effecting a partial or complete cure for a disease and/or symptoms of the disease. “Treatment,” as used herein, may include treatment of a tumor in a mammal, particularly in a human, and includes: (a) preventing the disease or a symptom of a disease from occurring in a subject which may be predisposed to the disease but has not yet been diagnosed as having it (e.g., including diseases that may be associated with or caused by a primary disease; (b) inhibiting the disease, i.e., arresting its development; and (c) relieving the disease, i.e., causing regression of the disease.

Treating may refer to any indicia of success in the treatment or amelioration or prevention of an cancer, including any objective or subjective parameter such as abatement; remission; diminishing of symptoms or making the disease condition more tolerable to the patient; slowing in the rate of degeneration or decline; or making the final point of degeneration less debilitating. The treatment or amelioration of symptoms can be based on objective or subjective parameters; including the results of an examination by a physician. Accordingly, the term “treating” includes the administration of the compounds or agents of the present invention to prevent or delay, to alleviate, or to arrest or inhibit development of the symptoms or conditions associated with ocular disease. The term “therapeutic effect” refers to the reduction, elimination, or prevention of the disease, symptoms of the disease, or side effects of the disease in the subject.

“In combination with”, “combination therapy” and “combination products” refer, in certain embodiments, to the concurrent administration to a patient of a first therapeutic and the compounds as used herein. When administered in combination, each component can be administered at the same time or sequentially in any order at different points in time. Thus, each component can be administered separately but sufficiently closely in time so as to provide the desired therapeutic effect.

As used herein, the term “correlates,” or “correlates with,” and like terms, refers to a statistical association between instances of two events, where events include numbers, data sets, and the like. For example, when the events involve numbers, a positive correlation (also referred to herein as a “direct correlation”) means that as one increases, the other increases as well. A negative correlation (also referred to herein as an “inverse correlation”) means that as one increases, the other decreases.

“Dosage unit” refers to physically discrete units suited as unitary dosages for the particular individual to be treated. Each unit can contain a predetermined quantity of active compound(s) calculated to produce the desired therapeutic effect(s) in association with the required pharmaceutical carrier. The specification for the dosage unit forms can be dictated by (a) the unique characteristics of the active compound(s) and the particular therapeutic effect(s) to be achieved, and (b) the limitations inherent in the art of compounding such active compound(s).

“Pharmaceutically acceptable excipient” means an excipient that is useful in preparing a pharmaceutical composition that is generally safe, non-toxic, and desirable, and includes excipients that are acceptable for veterinary use as well as for human pharmaceutical use. Such excipients can be solid, liquid, semisolid, or, in the case of an aerosol composition, gaseous.

“Pharmaceutically acceptable salts and esters” means salts and esters that are pharmaceutically acceptable and have the desired pharmacological properties. Such salts include salts that can be formed where acidic protons present in the compounds are capable of reacting with inorganic or organic bases. Suitable inorganic salts include those formed with the alkali metals, e.g. sodium and potassium, magnesium, calcium, and aluminum. Suitable organic salts include those formed with organic bases such as the amine bases, e.g., ethanolamine, diethanolamine, triethanolamine, tromethamine, N methylglucamine, and the like. Such salts also include acid addition salts formed with inorganic acids (e.g., hydrochloric and hydrobromic acids) and organic acids (e.g., acetic acid, citric acid, maleic acid, and the alkane- and arene-sulfonic acids such as methanesulfonic acid and benzenesulfonic acid). Pharmaceutically acceptable esters include esters formed from carboxy, sulfonyloxy, and phosphonoxy groups present in the compounds, e.g., C₁₋₆ alkyl esters. When there are two acidic groups present, a pharmaceutically acceptable salt or ester can be a mono-acid-mono-salt or ester or a di-salt or ester; and similarly where there are more than two acidic groups present, some or all of such groups can be salified or esterified. Compounds named in this invention can be present in unsalified or unesterified form, or in salified and/or esterified form, and the naming of such compounds is intended to include both the original (unsalified and unesterified) compound and its pharmaceutically acceptable salts and esters. Also, certain compounds named in this invention may be present in more than one stereoisomeric form, and the naming of such compounds is intended to include all single stereoisomers and all mixtures (whether racemic or otherwise) of such stereoisomers.

The terms “pharmaceutically acceptable”, “physiologically tolerable” and grammatical variations thereof, as they refer to compositions, carriers, diluents and reagents, are used interchangeably and represent that the materials are capable of administration to or upon a human without the production of undesirable physiological effects to a degree that would prohibit administration of the composition.

A “therapeutically effective amount” means the amount that, when administered to a subject for treating a disease, is sufficient to effect treatment for that disease.

“Suitable conditions” shall have a meaning dependent on the context in which this term is used. That is, when used in connection with an antibody, the term shall mean conditions that permit an antibody to bind to its corresponding antigen. When used in connection with contacting an agent to a cell, this term shall mean conditions that permit an agent capable of doing so to enter a cell and perform its intended function. In one embodiment, the term “suitable conditions” as used herein means physiological conditions.

The term “inflammatory” response is the development of a humoral (antibody mediated) and/or a cellular (mediated by antigen-specific T cells or their secretion products) response. An “immunogen” is capable of inducing an immunological response against itself on administration to a mammal or due to autoimmune disease.

The terms “biomarker,” “biomarkers,” “marker” or “markers” refer to, without limitation, cytokines, chemokines, growth factors, proteins, peptides, nucleic acids, oligonucleotides, and metabolites, together with their related metabolites, mutations, variants, polymorphisms, modifications, fragments, subunits, degradation products, elements, and other analytes or sample-derived measures. Markers can also include mutated proteins, mutated nucleic acids, variations in copy numbers and/or transcript variants. Markers also encompass non-blood borne factors and non-analyte physiological markers of health status, and/or other factors or markers not measured from samples (e.g., biological samples such as bodily fluids), such as clinical parameters and traditional factors for clinical assessments. Markers can also include any indices that are calculated and/or created mathematically. Markers can also include combinations of any one or more of the foregoing measurements, including temporal trends and differences.

To “analyze” includes determining a set of values associated with a sample by measurement of a marker (such as, e.g., presence or absence of a marker or constituent expression levels) in the sample and comparing the measurement against measurement in a sample or set of samples from the same subject or other control subject(s). The markers of the present teachings can be analyzed by any of various conventional methods known in the art. To “analyze” can include performing a statistical analysis to, e.g., determine whether a subject is a responder or a non-responder to a therapy.

A “sample” in the context of the present teachings refers to any biological sample that is isolated from a subject. A sample can include, without limitation an aliquot of body fluid, whole blood, serum, plasma, tissue biopsies, synovial fluid, lymphatic fluid, ascites fluid, and interstitial or extracellular fluid. The term “sample” also encompasses the fluid in spaces between cells, including gingival crevicular fluid, bone marrow, cerebrospinal fluid (CSF), saliva, mucous, sputum, semen, sweat, urine, or any other bodily fluids. “Blood sample” can refer to whole blood or any fraction thereof, including serum and plasma. Samples can be obtained from a subject by means including but not limited to venipuncture, excretion, ejaculation, massage, biopsy, needle aspirate, lavage, scraping, surgical incision, or intervention or other means known in the art.

A “dataset” is a set of numerical values resulting from evaluation of a sample (or population of samples) under a desired condition. The values of the dataset can be obtained, for example, by experimentally obtaining measures from a sample and constructing a dataset from these measurements; or alternatively, by obtaining a dataset from a service provider such as a laboratory, or from a database or a server on which the dataset has been stored. Similarly, the term “obtaining a dataset associated with a sample” encompasses obtaining a set of data determined from at least one sample. Obtaining a dataset encompasses obtaining a sample, and processing the sample to experimentally determine the data, e.g., via measuring, PCR, microarray, one or more primers, one or more probes, antibody binding, or ELISA. The phrase also encompasses receiving a set of data, e.g., from a third party that has processed the sample to experimentally determine the dataset. Additionally, the phrase encompasses mining data from at least one database or at least one publication or a combination of databases and publications.

“Measuring” or “measurement” in the context of the present teachings refers to determining the presence, absence, quantity, amount, or effective amount of a substance in a clinical or subject-derived sample, including the presence, absence, or concentration levels of such substances, and/or evaluating the values or categorization of a subject's clinical parameters based on a control.

Classification can be made according to predictive modeling methods that set a threshold for determining the probability that a sample belongs to a given class. The probability preferably is at least 50%, or at least 60% or at least 70% or at least 80% or higher. Classifications also can be made by determining whether a comparison between an obtained dataset and a reference dataset yields a statistically significant difference. If so, then the sample from which the dataset was obtained is classified as not belonging to the reference dataset class. Conversely, if such a comparison is not statistically significantly different from the reference dataset, then the sample from which the dataset was obtained is classified as belonging to the reference dataset class.

The predictive ability of a model can be evaluated according to its ability to provide a quality metric, e.g. AUC or accuracy, of a particular value, or range of values. In some embodiments, a desired quality threshold is a predictive model that will classify a sample with an accuracy of at least about 0.7, at least about 0.75, at least about 0.8, at least about 0.85, at least about 0.9, at least about 0.95, or higher. As an alternative measure, a desired quality threshold can refer to a predictive model that will classify a sample with an AUC (area under the curve) of at least about 0.7, at least about 0.75, at least about 0.8, at least about 0.85, at least about 0.9, or higher.

As is known in the art, the relative sensitivity and specificity of a predictive model can be “tuned” to favor either the selectivity metric or the sensitivity metric, where the two metrics have an inverse relationship. The limits in a model as described above can be adjusted to provide a selected sensitivity or specificity level, depending on the particular requirements of the test being performed. One or both of sensitivity and specificity can be at least about at least about 0.7, at least about 0.75, at least about 0.8, at least about 0.85, at least about 0.9, or higher.

Unless otherwise apparent from the context, all elements, steps or features of the invention can be used in any combination with other elements, steps or features.

General methods in molecular and cellular biochemistry can be found in such standard textbooks as Molecular Cloning: A Laboratory Manual, 3rd Ed. (Sambrook et al., Harbor Laboratory Press 2001); Short Protocols in Molecular Biology, 4th Ed. (Ausubel et al. eds., John Wiley & Sons 1999); Protein Methods (Bollag et al., John Wiley & Sons 1996); Nonviral Vectors for Gene Therapy (Wagner et al. eds., Academic Press 1999); Viral Vectors (Kaplift & Loewy eds., Academic Press 1995); Immunology Methods Manual (I. Lefkovits ed., Academic Press 1997); and Cell and Tissue Culture: Laboratory Procedures in Biotechnology (Doyle & Griffiths, John Wiley & Sons 1998). Reagents, cloning vectors, and kits for genetic manipulation referred to in this disclosure are available from commercial vendors such as BioRad, Stratagene, Invitrogen, Sigma-Aldrich, and ClonTech.

The invention has been described in terms of particular embodiments found or proposed by the present inventor to comprise preferred modes for the practice of the invention. It will be appreciated by those of skill in the art that, in light of the present disclosure, numerous modifications and changes can be made in the particular embodiments exemplified without departing from the intended scope of the invention. Due to biological functional equivalency considerations, changes can be made in protein structure without affecting the biological action in kind or amount. All such modifications are intended to be included within the scope of the appended claims.

The subject methods are used for prophylactic or therapeutic purposes. As used herein, the term “treating” is used to refer to both prevention of relapses, and treatment of pre-existing conditions. For example, the prevention of inflammatory disease can be accomplished by administration of the agent prior to development of a relapse. The treatment of ongoing disease, where the treatment stabilizes or improves the clinical symptoms of the patient, is of particular interest.

### Methods

A sample from an individual is analyzed for the presence of microvesicles, which are optionally detectable labeled for one or more markers of interest. Parameters of interest include microvesicle size, quantity, presence of RNA of interest, presence of proteins of interest, presence of lipids of interest.

Flow cytometry may be used in the analysis and sorting of the vesicles. FACS fluidics configurations include, in addition to routine 0.22 μm prefiltering for sheath fluid, inline filters of from about 0.02 to about 0.1 μm to minimize particulate noise. Filters of interest may be from about 0.05 to about 0.1 μm, although sheath pressure may be increased to deliver stable pressure. The flow cytometry optical configurations are typically also adjusted for the small particles, using a high magnification lens, which images the scattered stream on a pinhole for detection of low noise detection of small signals while preserving linearity for detecting large signals.

The signature pattern can be generated from a biological sample using any convenient protocol. The readout can be a mean, average, median or the variance or other statistically or mathematically-derived value associated with the measurement. The marker readout information can be further refined by direct comparison with the corresponding reference or control pattern. A binding pattern can be evaluated on a number of points: to determine if there is a statistically significant change at any point in the data matrix; whether the change is an increase or decrease in the binding; whether the change is specific for one or more physiological states, and the like. The absolute values obtained for each marker under identical conditions will display a variability that is inherent in live biological systems and also reflects the variability inherent between individuals.

Following obtainment of the signature pattern from the sample being assayed, the signature pattern is compared with a reference or control profile to make a prognosis regarding the phenotype of the patient from which the sample was obtained/derived. Typically a comparison is made with a sample or set of samples from an unaffected, normal source. Additionally, a reference or control signature pattern can be a signature pattern that is obtained from a sample of a patient known to be responsive or non-responsive to the therapy of interest, and therefore can be a positive reference or control profile.

In certain embodiments, the obtained signature pattern is compared to a single reference/control profile to obtain information regarding the phenotype of the patient being assayed. In yet other embodiments, the obtained signature pattern is compared to two or more different reference/control profiles to obtain more in depth information regarding the phenotype of the patient. For example, the obtained signature pattern can be compared to a positive and negative reference profile to obtain confirmed information regarding whether the patient has the phenotype of interest.

The detection reagents can be provided as part of a kit. Thus, the invention further provides kits for detecting the presence of a panel of specific markers of interest in a biological sample. Procedures using these kits can be performed by clinical laboratories, experimental laboratories, medical practitioners, or private individuals. The kits of the invention for detecting markers comprise affinity reagents useful for generating a prognostic signature pattern, which can be provided in solution or bound to a substrate. The kit can optionally provide additional components that are useful in the procedure, including, but not limited to, buffers, developing reagents, labels, reacting surfaces, means for detection, control samples, standards, instructions, and interpretive information.

In addition to the above components, the subject kits will further include instructions for practicing the subject methods. These instructions can be present in the subject kits in a variety of forms, one or more of which can be present in the kit. One form in which these instructions can be present is as printed information on a suitable medium or substrate, e.g., a piece or pieces of paper on which the information is printed, in the packaging of the kit, in a package insert, etc. Yet another means would be a computer readable medium, e.g., diskette, CD, hard-drive, network data storage, etc., on which the information has been recorded. Yet another means that can be present is a website address which can be used via the internet to access the information at a removed site. Any convenient means can be present in the kits.

### Assessment of Patient Outcomes

Patient outcomes and status can be assessed using imaging-based criteria such as radiographic scores, clinical and laboratory criteria. Multiple different imaging, clinical and laboratory criteria and scoring systems have been and are being developed to assess disease activity and response to therapy in cancer, radiation exposure, and inflammatory diseases, etc.

A pattern can be obtained as a dataset for an indication of interest. The dataset comprises quantitative data for the presence in serum of at least 1 microvesicle marker, etc. The dataset optionally quantitative data for the presence in a clinical sample of other markers, including immune cell presence or specificity, clinical indices, and the like. A statistical test will provide a confidence level for a change in the expression, titers or concentration of markers between the test and control profiles to be considered significant, where the control profile can be for selected as appropriate. The raw data can be initially analyzed by measuring the values for each marker, usually in duplicate, triplicate, quadruplicate or in 5-10 replicate features per marker.

A test dataset is considered to be different than a control dataset if one or more of the parameter values of the profile exceeds the limits that correspond to a predefined level of significance.

To provide significance ordering, the false discovery rate (FDR) can be determined. First, a set of null distributions of dissimilarity values is generated. In one embodiment, the values of observed profiles are permuted to create a sequence of distributions of correlation coefficients obtained out of chance, thereby creating an appropriate set of null distributions of correlation coefficients (see Tusher et al. (2001) PNAS 98, 5116-21, herein incorporated by reference). This analysis algorithm is currently available as a software “plug-in” for Microsoft Excel know as Significance Analysis of Microarrays (SAM). The set of null distribution is obtained by: permuting the values of each profile for all available profiles; calculating the pair-wise correlation coefficients for all profile; calculating the probability density function of the correlation coefficients for this permutation; and repeating the procedure for N times, where N is a large number, usually 300. Using the N distributions, one calculates an appropriate measure (mean, median, etc.) of the count of correlation coefficient values that their values exceed the value (of similarity) that is obtained from the distribution of experimentally observed similarity values at given significance level.

The FDR is the ratio of the number of the expected falsely significant correlations (estimated from the correlations greater than this selected Pearson correlation in the set of randomized data) to the number of correlations greater than this selected Pearson correlation in the empirical data (significant correlations). This cut-off correlation value can be applied to the correlations between experimental profiles.

For SAM, Z-scores represent another measure of variance in a dataset, and are equal to a value of X minus the mean of X, divided by the standard deviation. A Z-Score tells how a single data point compares to the normal data distribution. A Z-score demonstrates not only whether a datapoint lies above or below average, but how unusual the measurement is. The standard deviation is the average distance between each value in the dataset and the mean of the values in the dataset.

Using the aforementioned distribution, a level of confidence is chosen for significance. This is used to determine the lowest value of the correlation coefficient that exceeds the result that would have obtained by chance. Using this method, one obtains thresholds for positive correlation, negative correlation or both. Using this threshold(s), the user can filter the observed values of the pairwise correlation coefficients and eliminate those that do not exceed the threshold(s). Furthermore, an estimate of the false positive rate can be obtained for a given threshold. For each of the individual “random correlation” distributions, one can find how many observations fall outside the threshold range. This procedure provides a sequence of counts. The mean and the standard deviation of the sequence provide the average number of potential false positives and its standard deviation.

The data can be subjected to non-supervised hierarchical clustering to reveal relationships among profiles. For example, hierarchical clustering can be performed, where the Pearson correlation is employed as the clustering metric. One approach is to consider a patient disease dataset as a “learning sample” in a problem of “supervised learning”. CART is a standard in applications to medicine (Singer (1999) Recursive Partitioning in the Health Sciences, Springer), which can be modified by transforming any qualitative features to quantitative features; sorting them by attained significance levels, evaluated by sample reuse methods for Hotelling's T² statistic; and suitable application of the lasso method. Problems in prediction are turned into problems in regression without losing sight of prediction, indeed by making suitable use of the Gini criterion for classification in evaluating the quality of regressions.

Other methods of analysis that can be used include logic regression. One method of logic regression Ruczinski (2003) Journal of Computational and Graphical Statistics 12:475-512. Logic regression resembles CART in that its classifier can be displayed as a binary tree. It is different in that each node has Boolean statements about features that are more general than the simple “and” statements produced by CART.

Another approach is that of nearest shrunken centroids (Tibshirani (2002) PNAS 99:6567-72). The technology is k-means-like, but has the advantage that by shrinking cluster centers, one automatically selects features (as in the lasso) so as to focus attention on small numbers of those that are informative. The approach is available as Prediction Analysis of Microarrays (PAM) software, a software “plug-in” for Microsoft Excel, and is widely used. Two further sets of algorithms are random forests (Breiman (2001) Machine Learning 45:5-32 and MART (Hastie (2001) The Elements of Statistical Learning, Springer). These two methods are already “committee methods.” Thus, they involve predictors that “vote” on outcome. Several of these methods are based on the “R” software, developed at Stanford University, which provides a statistical framework that is continuously being improved and updated in an ongoing basis.

Other statistical analysis approaches including principle components analysis, recursive partitioning, predictive algorithms, Bayesian networks, and neural networks.

These tools and methods can be applied to several classification problems. For example, methods can be developed from the following comparisons: i) all cases versus all controls, ii) all cases versus post-radiation exposure controls, iii) all cases versus non-exposed controls.

These statistical tools are applicable to all manner of marker data. A set of data that can be easily determined, and that is highly informative regarding detection of individuals with clinically significant responsiveness to therapy, exposure to radiation, etc. is provided.

Also provided are databases of signature patterns for patient status. Such databases will typically comprise signature patterns of individuals having phenotypes such as responsive, post-radiation, etc., where such profiles are as described above.

The analysis and database storage can be implemented in hardware or software, or a combination of both. In one embodiment of the invention, a machine-readable storage medium is provided, the medium comprising a data storage material encoded with machine readable data which, when using a machine programmed with instructions for using said data, is capable of displaying a any of the datasets and data comparisons of this invention. Such data can be used for a variety of purposes, such as patient monitoring, initial diagnosis, and the like. Preferably, the invention is implemented in computer programs executing on programmable computers, comprising a processor, a data storage system (including volatile and non-volatile memory and/or storage elements), at least one input device, and at least one output device. Program code is applied to input data to perform the functions described above and generate output information. The output information is applied to one or more output devices, in known fashion. The computer can be, for example, a personal computer, microcomputer, or workstation of conventional design.

Each program is preferably implemented in a high level procedural or object oriented programming language to communicate with a computer system. However, the programs can be implemented in assembly or machine language, if desired. In any case, the language can be a compiled or interpreted language. Each such computer program is preferably stored on a storage media or device (e.g., ROM or magnetic diskette) readable by a general or special purpose programmable computer, for configuring and operating the computer when the storage media or device is read by the computer to perform the procedures described herein. The system can also be considered to be implemented as a computer-readable storage medium, configured with a computer program, where the storage medium so configured causes a computer to operate in a specific and predefined manner to perform the functions described herein.

A variety of structural formats for the input and output means can be used to input and output the information in the computer-based systems of the present invention. One format for an output means test datasets possessing varying degrees of similarity to a trusted profile. Such presentation provides a skilled artisan with a ranking of similarities and identifies the degree of similarity contained in the test pattern.

The signature patterns and databases thereof can be provided in a variety of media to facilitate their use. “Media” refers to a manufacture that contains the signature pattern information of the present invention. The databases of the present invention can be recorded on computer readable media, e.g. any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; and hybrids of these categories such as magnetic/optical storage media. One of skill in the art can readily appreciate how any of the presently known computer readable mediums can be used to create a manufacture comprising a recording of the present database information. “Recorded” refers to a process for storing information on computer readable medium, using any such methods as known in the art. Any convenient data storage structure can be chosen, based on the means used to access the stored information. A variety of data processor programs and formats can be used for storage, e.g. word processing text file, database format, etc.

### Clinical Factors

In some embodiments, one or more clinical factors in a subject can be assessed. In some embodiments, assessment of one or more clinical factors in a subject can be combined with a marker analysis in the subject to identify status of the subject.

Various clinical factors are generally known one of ordinary skill in the art to be associated with the disease in question. In some embodiments, clinical factors known to one of ordinary skill in the art to be associated with the disease, can include age, gender, race, family history, and/or medications. In some embodiments, a clinical factor can include age at onset of disease, duration of therapeutic treatment, and/or the relapse rate of the subject.

It is to be understood that this invention is not limited to the particular methodology, protocols, cell lines, animal species or genera, and reagents described, as such may vary. It is also to be understood that the terminology used herein is for the purpose of describing particular embodiments only, and is not intended to limit the scope of the present invention which will be limited only by the appended claims.

The following examples are put forth so as to provide those of ordinary skill in the art with a complete disclosure and description of how to make and use the subject invention, and are not intended to limit the scope of what is regarded as the invention. Efforts have been made to ensure accuracy with respect to the numbers used (e.g. amounts, temperature, concentrations, etc.) but some experimental errors and deviations should be allowed for. Unless otherwise indicated, parts are parts by weight, molecular weight is average molecular weight, temperature is in degrees centigrade; and pressure is at or near atmospheric.

All publications and patent applications cited in this specification are herein incorporated by reference as if each individual publication or patent application were specifically and individually indicated to be incorporated by reference.

### EXPERIMENTAL

### Example 1

NanoFACS has been developed as a method for studying submicron particles in blood samples.

These submicron particles are associated with numerous biological conditions, and subsets and profiles of these particles are useful as minimally invasive biomarkers for monitoring immune responses, including the development of tumor immunity; tumor stage and treatment responses or progression; and radiation exposure.

Circulating submicron particles are being studied in many fields of medicine as biomarkers and mediators of disease. However, cytometric separation and functional studies of these particles have been limited by the small and overlapping sizes of these cell-derived particles. Exosomes, microvesicles, and apoptotic blebs represent morphologically and functionally distinct populations of submicron membrane-bound particles. Exosomes, which are formed in microvesicular bodies, secreted in a programmed manner, and measure 40-150 nm in diameter, are functionally and morphologically distinct from microparticles (100-1000 nm) that are shed by cells in response to stressors and stimuli, and distinct from apoptotic blebs (>800nm) that detach from dying cells early after induction of apoptosis.

Tumors, antigen presenting cells, and platelets produce especially large quantities of exosomes and circulating microparticles, with distinct surface receptor and miRNA repertoires, that have wide ranges of cellular and physiological effects, including malignant progression, immune modulation, and thrombosis. Although the biological effects of submicron particles are significant, size has been a barrier to functional sorting and analysis of subsets of these particles. In order to be able to fractionate submicron particles in functional forms, based on size and receptor staining, we developed a method for sorting these particles with nano-scale Fluorescence Activated Cell Sorting (nanoFACS). FACS has been widely used, but sorting of 20-400 nm submicron subpopulations has not been demonstrated previously.

To detect and sort subsets of exosomes and other submicron particles, we configured an Influx flow cytometer (BD Biosciences, San Jose, Calif.) for maximal resolution of small particles. Non-specific background noise was reduced by adding a 0.02 or 0.1 micron filter in the sheath fluid line close to the nozzle. A PMT and high magnification collection lens was added to the Forward Scatter (FSc) channel to increase sensitivity. Although FSc is conventionally used as a trigger parameter, we find that noise triggers in the FSc and SSc channels in our system overlap with the scatter signals from 200 nm and 100 nm particles, respectively. Thus, for discriminating and sorting unlabeled 100-1000 nm particles, SSc was used as a trigger signal. Lastly, the sorting conditions (drop drive amplitude and phase) were set so there was no increase in the sheath trigger rate. With this configuration, 100 nm polystyrene beads (Spherotech and Invitrogen) are detected and are sortable at and above the level of background SSc noise. If a fluorescent trigger is used, it is possible to measure and sort particles as small as 40 nm. 20-40 nm fluorescent particles demonstrate overlapping distributions detectable above the fluorescent threshold.

To demonstrate the utility of nanoFACS for fractionating distinct sub-micron sub-populations of biological interest, FSc vs SSC profiles of supernatants from irradiated dendritic cells were gated and sorted based on FSC gating. Counterstaining with CD9 and class I MHC APC-conjugated antibodies suggested that the smaller particles were DC2.4-derived exosomes. The largest particles were annexin V-FITC positive, consistent with apoptotic blebs or microparticles. The sorted populations demonstrated distinct morphological profiles by electron microscopy, consistent with the staining patterns measured. Diffusion light scattering and nanoparticle tracking analysis (DLS-NTA, Nanosight LM-10) gave further confirmation of the size distribution of the sorted populations.

NanoFACS extends the range of FACS-based single particle characterization and sorting by an order of magnitude. Sorting subsets of exosomes, microparticles, viruses, and other 40-1000 nm particles with nanoFACS will be useful in many fields of medicine for diagnostic assays, functional studies, and therapeutic enrichment or depletion.

Identification of unique exosome and microparticle profiles and subsets is clinically useful in many fields, and our focus is on developing these biomarkers for use in the fields of immunology, oncology, and biodefense. Identification of tumor- and immune cell-specific markers enables the use of submicron particles circulating in the serum to monitor tumor and immune cellular status. Combining these markers with radiation-specific markers enables monitoring the intratumoral microenvironment noninvasively. Additional applications in cardiology, hematology, infectious disease, and critical care also have rapid translational potential.

Tumor Immune Response Monitoring: For identification of exosome and microparticle profiles associated with anti-tumor immunity, there are well established mouse models of effective vs. suppressive immune responses. Plasma is sampled during the development of these immune responses to define submicron particle profiles that are positively (as with allogeneic tumor rejection) versus negatively associated (as with the development of immunosuppressive effects in the 4T1 breast cancer model) with anti-tumor immune responses. Treatment responses can be associated with distinct exosome profiles.

Tumor Progression Monitoring: Well-characterized mouse models of metastatic versus locally advanced breast cancer (4T1 and 4TO7, FARN, 67NR, respectively) are used to identify exosome and microparticle profiles associated with the development of metastases.

Radiation Response/Exposure Monitoring: In mice and humans treated with total body or localized tumor irradiation, data that shows distinct particle profiles. For example, increased microparticles in plasma are found from patients treated with a single large dose of localized irradiation for locally advanced pancreatic cancer.

### Example 2

To demonstrate the utility of this method for fractionating distinct sub-popultations, we examined biological fluids with unfractionated submicron particle populations and sorted separate exosome and microparticle populations. In serum and in dendritic cell cultures, exosomes predominate. DC2.4-derived exosomes were doubly positive for CD9 and class I MHC, with minimal annexin V staining. Microparticles, in contrast, are characterized by exposed phosphatidyl serime and were annexin V positive. We sorted these populations and demonstrated distinct morphological profiles by electron microscopy and confirmed nanoFACS-sorted particle sizes with diffusion light scattering nanoparticle DLS-NTA.

Characterization and sorting at a single particle level offers several advantages over currently available methods, which analyze of exosomes and other microparticles in bulk (unsorted) or as bead-bound aggregates. FACS has been a critical tool for determining cell types, functions, and lineages in immunology, stem cell biology, and microbiology. NanoFACS is useful for sorting subsets of 40-1000 nm particles, including exosomes, microparticles, viruses, and microbes, for diagnostic and functional studies that were not previously feasible. NanoFACS will benefit a diverse group of scientists studying nano-scale biological particles in fields as wide ranging as medicine, biodefense, and marine biology. Particles that can be analyzed and sorted by the methods of the invention include:

| | Exosomes | Microparticles (MPa) | Apoptotic Bodies |
|---|---|---|---|
| Size | 40-450 nm | 50-1000 nm | >500 nm |
| Surface Markers | APC-specific: CD [symbol] 1, CD9, MHC-II; | Annexin V; [symbol] -, [symbol] , P- [symbol] from | Annexin V; v [symbol] [symbol] cell of |
| | either; CD [symbol] , [symbol] integrin, MHC-I, | plate [symbol] CD [symbol] 1, CD146 from endo [symbol] | [symbol] |
| | [symbol] - [symbol] | cells; CD4, - [symbol] , - [symbol] from [symbol] | |
| Common sources | Antigen presenting cells (AlP [symbol] ), | Platelets, stressed cells | Apoptotic cells |
| | stressed cells, [symbol] | | |
| Critical ‘Cargo’ | miRNAs, mRNA, DNA, receptors | Cytokines, RNA, DNA, receptors | |
| | cyto [symbol] ( [symbol] - [symbol] TGF- [symbol] ) | | |
| Inducing Factors | Antigen, Cell [symbol] ( [symbol] , RT) | Cell stressors, F [symbol] Activating Factors | Apoptosis |
| Biological Effects | Immerse s [symbol] & suppression, | Ti [symbol] , vascular dysfunction, stress | I [symbol] suppression |
| | cell [symbol] & [symbol] , ang [symbol] | cell engraftment, i [symbol] effects | |

[symbol]

indicates data missing or illegible when filed

### Methods:

FACS fluidics configurations: In addition to the use of routine 0.22 μm prefiltering for sheath fluid, we tested inline filters 0.02 and 0.1 um to minimize particulate noise in the sheath fluid. Use of a 0.1 μm filter in the sheath line close to the nozzle eliminates >99% of the detectable particulate debris. With the 0.1 um filter, it was necessary to increases the sheath pressure from 20 psi to 23 psi to deliver the same pressure to the nozzle, and consistent sheath flow rates were more stable with 0.1 instead of 0.02 um filtering.

SSC trigger vs. FL-1 trigger. By triggering on the fluorescent signal, we determined the proportion of particles below the SSC threshold by determining the ratio of particles identified by fluorescent labeling above and below the SSC SSC-488 threshold.

Flow cytometry optical configurations: A BD Influx flow cytometer was configured with a high magnification lens (20×), with images the scattered stream on a 0.7 mm pinhole. Light passing the pinhole is detected by a PMT for detection of low noise detection of small signals, while preserving linearity for detecting large signals. Variances were compared for the FSC and SSC channels, to confirm superior small particle size resolution with SSC. SSC and FSc gains were adjusted to place 400 nm particles near the top of the scale, and the SSC threshold was adjusted for a count rate on sheath fluid of 20-70 events/sec with the drop drive off.

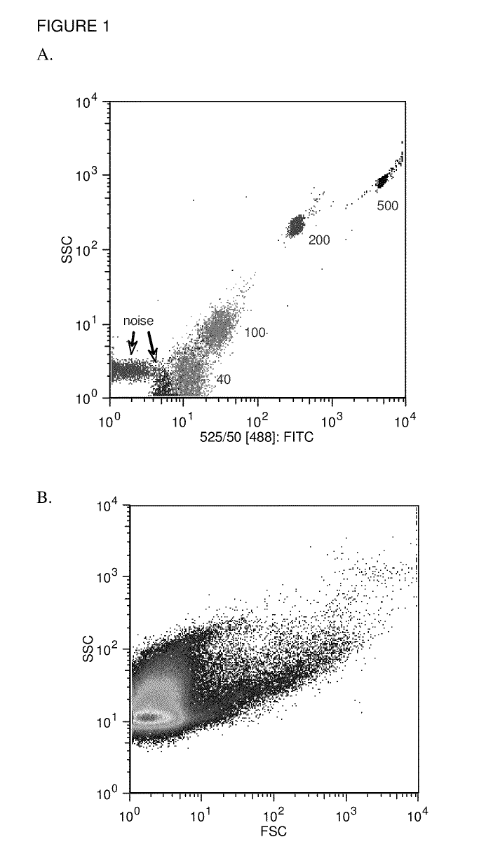

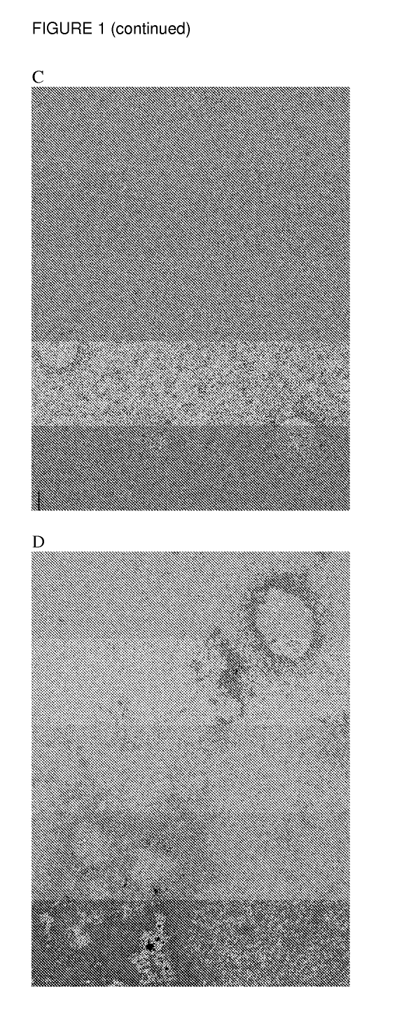

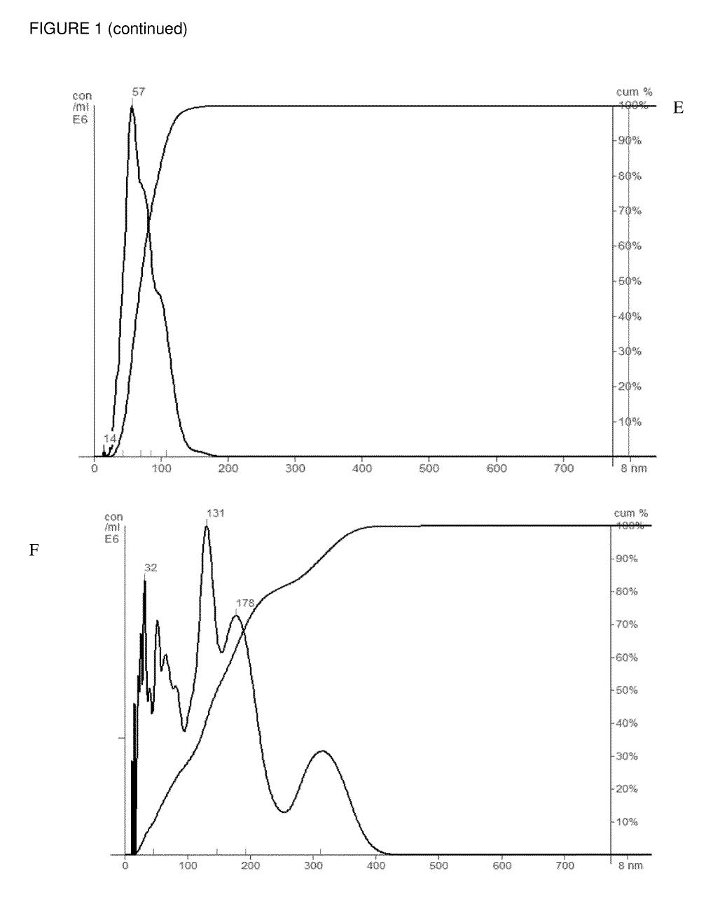

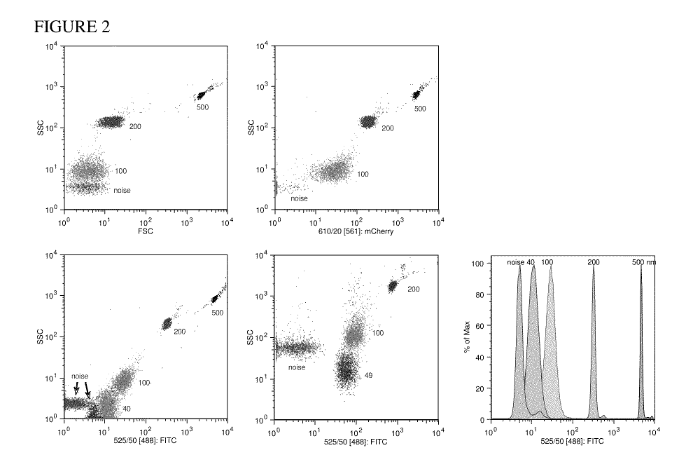

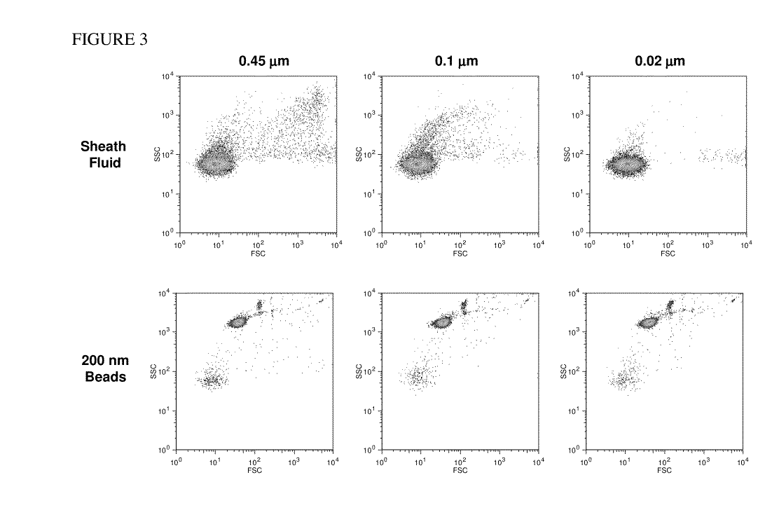

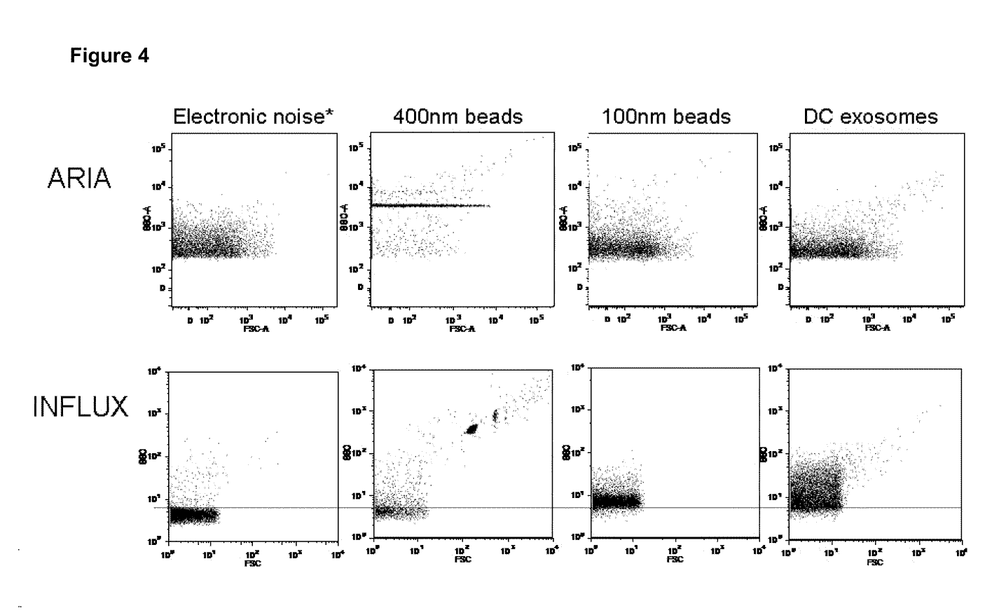

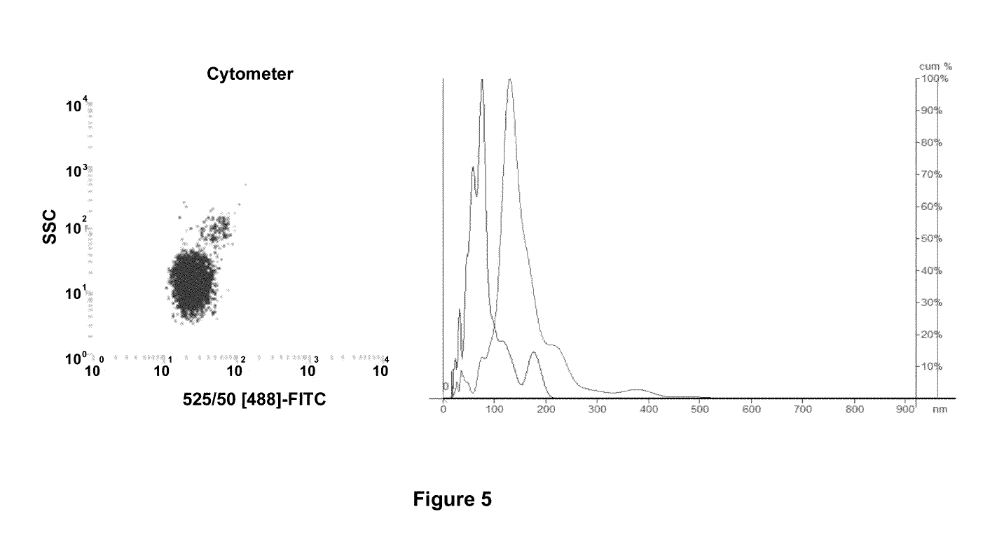

Nanoscale Particle Resolution: 20-500 nm dye-incorporated particles (Fluospheres, Molecular Probes) were resolved by triggering at 2-10 events/second above the fluorescent noise level (FIG. 1B; comparable resolution was not feasible with BD Aria instruments, fig. S3). Membrane-bound submicron particles have larger SSc:size ratios than polystyrene beads, and, therefore, biological particles as small are detected above the SSc noise threshold. We confirmed the sizes of particles sorted by SSc/FSc distribution with this nanoFACS configuration using diffusion light scattering and nanoparticle tracking analysis (DLS-NTA, Nanosight LM-10; FIG. 5).

1. A methods are provided for the flow cytometry profiling of microvesicles, including exosomes.

2. The method of claim 1, wherein the profiling is performed with nanoFACs.

3. The method of claim 2, wherein the nanoFACs utilizes a flow cytometer tuned for maximal resolution of small particles by adding both a filter and a small particle detector, as well as tuning the nozzle height to eliminate drop drive noise.

4. The method of claim 1, comprising analysis of the quantity and/or quality of microvesicles for monitoring of tumor responses to cytotoxic therapies.

5. The method of claim 1, comprising analysis of the quantity and/or quality of microvesicles for monitoring immune responses to tumor vaccines.

6. The method of claim 1, comprising analysis of the quantity and/or quality of microvesicles for monitoring immune cells following transplantation.

7. The method of claim 1, comprising analysis of the quantity and/or quality of microvesicles for biodosimetry to assess the level of radiation exposure.

8. The method of claim 1, comprising utilizing a point of care device for purposes of identifying individuals with radiation exposure or specific infections.

9. The method of claim 1, comprising staining a population of microvesicles with a detectably labeled affinity reagent specific for a marker of interest, prior to analysis.

10. The method of claim 1, wherein the method further comprises selecting a therapeutic regimen based on the analysis.

11. A kit for use in the methods of claim 1.
